(19) United States
(12) Patent Application Publication
(10) Pub. No.: US 2002/0067714 A1
(43) Pub. Date: Jun. 6, 2002

(54) System and method for wide area network and telco infrastructure integration

(76) Inventors: Louis M. Crain, Culver City, CA (US); Steven F. Hamilton, Culver City, CA (US); Tony Lam, Culver City, CA (US)

Correspondence Address: STRADLING YOCCA CARLSON & RAUTH, IP Department, Suite 1600, P.O. Box 7680, 660 Newport Center Drive, Newport Beach, CA, 92660-6441, US

(21) Appl. No.: 09/966,371

(22) Filed: Sep. 28, 2001

Related U.S. Application Data
(60) Provisional application No. 60/236,215, filed on Sep. 28, 2000.

(51) Int. Cl. H04L 12/66

(52) U.S. Cl. 370/352; 370/465

(57) ABSTRACT

Apparatus and methods for integrating multi-mode communication modalities are implemented in a communication platform nexus which is coupled to the public switch telephone network, a wide area data network and a wireless communication network. The communication platform receives communication attempts directed at a subscriber, from communication devices without regard to their underlying network transport medium. The platform receives and processes communication attempts and forwards attempted communications to the subscriber over all of the communication media available to the platform, simultaneously. Caller-id information is directed to a subscriber along with an interactivity option selection list, over a wide area data network link. A subscriber enters interaction options selections as call control signals and forwards the signals to the platform over the wide area data network link. The communication platform manages incoming communications, in accordance with the call control signals, so as to notify the subscriber of a communication attempt regardless of the subscriber's location and the form of communication device with which they are presently equipped.

### CROSS REFERENCE TO RELATED APPLICATIONS

The present application is related to and takes priority from Provisional Application Serial No. 60/236,215, filed Sep. 28, 2000, entitled SYSTEM AND METHOD FOR WIDE AREA NETWORK AND TELCO INFRASTRUCTURE INTEGRATION, commonly owned by the assignee of the present invention, the entire contents of which are expressly incorporated herein by reference.

### FIELD OF THE INVENTION

The present invention relates generally to telephony processing over a wide area data network and, more particularly, to a single-number telecommunication system integrating telephony, wireless and wide area network communications.

### BACKGROUND OF THE INVENTION

Over the past several years, the world has become more informationally interconnected—people using a wide variety of devices in order to obtain the various forms of information that they need. This revolution in modern communications began with the development of the mass media of radio and television which subsequently joined the traditional medium of print. These three media can be considered to be similar, in that they broadcast, for the most part, non-specific, untailored information.

Several years ago, in the early 1980's, numeric paging technology was introduced. This communication modality allowed people to receive numeric pages (i.e., a numeric calling telephone number) virtually anywhere in the country which was facilitated with wireless, paging relay towers. Today, the infrastructure to support paging transmissions exists nationwide. This technology is relatively simple and inexpensive to maintain. In particular, modern paging equipment enables data to be transmitted at speeds up to 6400 baud (more than 6400 bits of information per second), although certain systems retain the current POCSAG (Post Office Code Standardization Advisory Group) data transmission rate of 512 to 2400 baud. Modern paging systems accommodate multi-channel operation over the 138-174 MHz frequency range. Not content with supporting numeric pages, paging technology has evolved to the extent that alpha-numeric characters are routinely transmitted and received on evermore sophisticated consumer devices.

Messages may originate from many sources, the most common of which was the public switch telephone network (PSTN). With the introduction of alpha-numeric and two-way messaging, sources for paging have expanded and now include specialized paging input devices, personal computers, sites on the Internet, and other pagers or wireless devices. Regardless of the origination point, pages usually must pass through a paging terminal which interfaces to the public switch telephone network (PSTN) in order to permit subscribers to dial up and send pages from their telephones using dual tone multi-frequency (DTMF).

With the advent of the Internet and the explosion of e-commerce, paging terminals need to accept messages from new sources such as e-mail and the World Wide Web. Most paging terminals do not directly support the mail and Internet protocols such as SMTP and HTTP. The most common solution to this problem is for infrastructure suppliers to develop gateways that translate between the Internet protocols and the paging protocols supported by paging terminals.

The revolution in modern communications continued with the introduction of cellular telephony technology, making it possible for people to maintain telephonic communication while mobile. Cellular technology has similar limitations to pager technology in that coverage is limited to major metropolitan areas and highly-traveled local commuter and interstate routes, mainly by virtue of the expense associated with developing and populating relatively large areas with relay “cells.” The cellular approach typically requires a large number of base stations in a locality of any size. A typical large city can have hundreds of towers, but because so many people are using cellular telephones, costs remain low per user. Each carrier, in each local region (LATA), runs one central office termed a MOBILE TELEPHONE SWITCHING OFFICE (MTSO) which handles all of the telephony communications between the cellular system and the normal land-based phone system, as well as controlling all of the base stations in the carrier region. However, penetration into cellular technology has been limited due to its perceived high device and usage costs.

In summary, radio, television, paging, and telephony (whether POTS or cellular) have not changed fundamentally since their introduction. They have, however, set the stage for the most recent revolution in communications, the Internet. The Internet has transformed the way in which people interact with one another and how they interact with information. One of the most important aspects of the Internet is that the information conveyed is digital, enabling it to be viewed, manipulated, adapted, refined, and combined with other information, images and sound, in order to produce entirely new information. The Internet has also dramatically changed the nature and availability of information, thereby allowing people to easily obtain precisely the information of interest to them and, similarly, allowing content providers to more narrowly target information to individuals. If there has been a limitation to the Internet, it is that it requires people to be tied to their computers.

The next logical step in the evolution of communications technology must overcome the lack of broad geographic coverage and the high cost of cellular technology, as well as the physicality and static nature of information communication over computer networks. Systems should be able to utilize existing low-cost paging infrastructure in order to transmit not just telephone numbers or short alpha-numeric messages, but true information and content. It should connect to the Internet in order to deliver textual content to customers and allow that content to be tailored in real-time based on customer preferences and demographics. A modern communication technology methodology should support information transmission between all types of devices, from pagers to personal digital assistants (PDAs), to cellular telephones and wireless-enabled portable personal computers (PCs). Accordingly, an individual should be able to utilize the previously mentioned data terminal-type devices, in addition to conventional telephones, facsimile machines and the Internet, in order to keep fully connected to the information they require.

A further difficulty with some of the above-mentioned communication methodologies is that each of them can only be accessed through a single, unique identification code, such as a telephone number, DNS address, or the like. For an individual having a home telephone number, work telephone number, cellular telephone number, pager number and reachable over perhaps a work, home and mobile laptop personal computer, one attempting to contact such an individual must somehow have five telephone numbers and three Internet e-mail addresses available to them. In this regard, single-number and unified messaging solutions are one means by which individuals are able to utilize a telephone as a tool to keep all of their communications convenient and integrated through the use of a simple telephone. Combining voice, voice mail, long distance, e-mail, fax, and an array of other voice-activated and voice-delivered services, unified messaging is changing the way people interact with others. The unified messaging concept involves breaking down the terminal and media barriers so that people using different technologies, different media, and different terminal devices can still communicate with one another at any time.

Although conceptually very interesting and certainly representative of the directions that communication technology is moving, unified messaging has not yet been implemented to the degree required to fulfill the promise of seamless communication over time, distance, media and communication device. In addition to accommodating voice and fax messages, a unified messaging platform must also accommodate e-mail text messages as well as Internet information and content. What is required, therefore, is a tightly integrated, robust architecture, that would interface with and fit the needs of both TELCO and Internet service providers.

### SUMMARY OF THE INVENTION

In a telecommunication system coupled to communicate between a public switch telephone network, a wide area data network and a wireless communication network, a method for controlling the acceptance or rejection of a telephone call or a wide area data network comprises the sets of providing a remote data terminal device couple to a wide area data network and providing a communication platform, configured as a switch, the platform coupled to communicate over the public switch telephone network, the wide area data network and the wireless communication network. A communication link is established between the remote data terminal device and the communication platform using a wide area data network link. Telephone communication attempt, directed at a subscriber, is received over the PSTN by the communication platform and an alert notification is generated to the subscriber regarding the telephone communication attempt. The alert notification is forwarded to the subscriber over the public switch telephone network, the wide area data network and the wireless communication network simultaneously.

In one aspect of the invention, the subscriber is offered an interactivity option selection list over the wide area data network link. ANI/CLID/CNID information is acquired from the telephone communication attempt and the acquired information is displayed to the subscriber over the wide area data network link. The ANI/CLID/CNID information is translated from text to voice and a voice analog signal is generated (a computer analog), whereby the ANI/CLID/CNID information is read to a subscriber wireless communication device over the wireless communication network.

In a further aspect of the invention, a database of subscriber feature flags is provided and, in the event of a telephone communication attempt, the system determines whether a security flag is enabled within the database. An IVRS request is generated that requests a calling party to enter a security code. A match is performed between the entered security code and a code sequence associated to the called subscriber and the telephone communication attempt is forwarded to the subscriber if a match is found between the entered security code and the code sequence associated to the subscriber.

In a further aspect of the invention, a personalized profile record, uniquely associated with each subscriber, is prepared and stored in a database associated to the data network portion of the communication platform. The personalize profile records comprises a plurality of communication device identification indicia (such as telephone numbers), the communication devices simultaneously accessible through the platform regardless of the underlying network transport medium. A telephone communication attempt is directed at a subscriber and is received by the communication platform over the PCTN. The system consults the subscriber's personalize profile record and generates an alert notification to the subscriber regarding the telephone communication attempt. The alert notification is forwarded to each of the subscriber's plurality of communication devices, as identification in the database profile record. Communication devices are simultaneously accessible through the platform without regard to the underlying network transport medium.

### BRIEF DESCRIPTION OF THE DRAWINGS

These and other features, aspects and advantages of the present invention will be more fully understood when considered with respect to the following specification, appended claims, and accompanying drawings, wherein:

FIG. 1 is a semi-schematic block diagram of an integrated infrastructure system coupled to a PSTN and a data network, in accordance with the present invention;

FIG. 2 is an exemplary screen shot of a notification pop-up application window in accord with the present invention;

FIG. 3 is an exemplary screen shot of a subscriber interaction option pop-up application window in accord with the present invention;

FIG. 4 is an exemplary logical flow diagram of an interactive call return process according to the invention;

FIG. 5 is an exemplary logical flow diagram of a call screening with number prompting process according to the invention; and

FIG. 6 is an exemplary logical flow diagram of a simultaneous soft call waiting process according to the invention.

### DESCRIPTION OF THE INVENTION

Briefly, the invention might be characterized as a telecommunications technology engine, implemented in the form of an application service provider (ASP), delivering integrated communications, including wireless delivery of information (including the Wireless Web), integrated with advanced telephony services and the consolidation of all messaging using a single communications platform. Integrated communications incorporates single-number contact solutions, the Wireless Web, and unified messaging using a single, low-cost hardware/software system to provide individuals and businesses with unprecedented levels of communication flexibility.

The hardware platform is an open architecture platform that is able to communicate with virtually all wireless devices including numeric and alpha-numeric pagers, two-way pagers, PDAs such as the Palm VII and compatibles, cellular phones including WAP- and PCS-enabled devices, as well as wireless-enabled portable computers. Additionally, the system is able to integrate with any computer on the Internet and any telephone, by utilizing the World Wide TELCO and Internet infrastructure in order to provide its services.

Using this system, an individual is able to send and receive information to and from almost any source device including any telephone, mobile appliance, the Internet, voice mail, e-mail and facsimile machine. The users are able to utilize the Internet to provision the system in order to have optional information pushed to them based upon notification criteria which they establish.

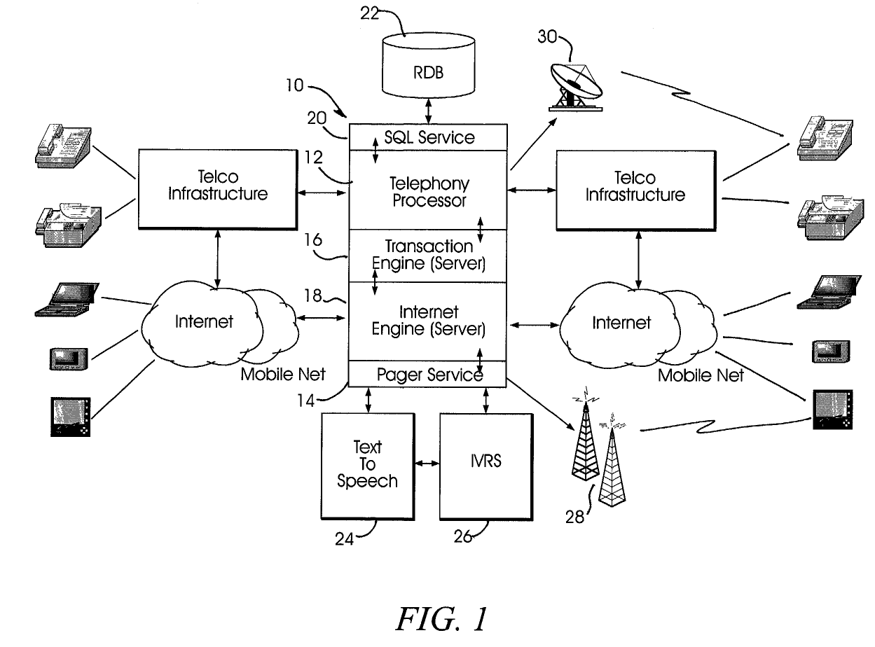

Turning now to FIG. 1, there is illustrated an integrated communication platform, indicated generally at 10, which is positioned to function as a communication nexus between message originators and message recipients, regardless of the message's underlying transport medium. Voice telephone calls, pages or facsimiles, adapted to be communicated over the TELCO infrastructure, are received and processed by the system's message handling system, prior to being returned to the TELCO infrastructure for forwarding to a recipient's telephone, cell phone, or the like. Similarly, inbound messages originating on data terminal-type devices and utilizing the Internet as a transport medium are also intercepted by the system and processed prior to being returned either to the Internet or the TELCO infrastructure for forwarding to a particular type of communication device identified by a subscribing customer.

The communication platform 10 is a multi-function switch that front-ends mobile phone switches, call center environments, business offices and paging infrastructures. Platform hardware is further configured to appear to the PSTN as a competitive local exchange carrier (CLEC) and communication signaling is established between the system and the PSTN through a conventional class-5 switch or, alternatively, as a class-4 switch if the system needs to appear less like a local telephone central office and more like a telephone tandem office, such as an inter-exchange carrier (IXE). It should be noted, however, that the coupling methodology (class-5 or class-4) is not particularly relevant to practice the present invention. The distinction between class-4 and class-5 switches is mainly historical, with class-4 switches dealing with high-speed, 4-wire, T1, T3 and OC-3 connections in contrast to 2-wire local lines associated with class-5 switches. Currently, both class-4 and class-5 switches are configured to support 4-wire lines.

Further, the communication platform supports a variety of communication protocols including TNPP, TAP, SNPP, SMS, WAP, POP3, IMAP4, WMTP, VAP, SMTP, PCS and G3 when called for. Characteristically, the communication platform is standards based, utilizing software components running under the Microsoft NT Windows 2000 operating system, manufactured and sold by Microsoft Corporation of Redmond, Wash.

In addition to its ability to interface with TELCO systems, the communication platform also includes a pager service module 14 which accesses a local paging infrastructure, in conventional fashion, in order to provide voice mail, paging and numeric retrieval, as well as supporting wireless communication with personal digital assistants, 2-way pages, or pagers on other networks.

The telephony processor 12 is configured as an enhanced service provider which provides, via the connection to an exchange carrier, additional telephony services that enhance the informational content of a telephone call. In particular, the telephony processor 12 provides call forwarding, call routing and calling card support as well as advanced call routing, controlled by way of an Internet connection, which allows individuals to retrieve their messages, faxes, pages and call detail records from a centralized message center, hosting on the Internet.

Suitably, the communications platform 10 comprises a transaction server 16 and Internet information server 18 which, in combination, function to allow the system to operate as an application service provider (ASP). The transaction server 16 and Internet information server 18 allow the system to connect to and interact with information flowing across the World Wide Web. Additionally, the platform suitably includes an SQL server 20 which allows users to access data in a relational database 22 and which also allows users to define the data in the database and manipulate that data. The relational database 22 contains real-time customer data, which is used, in a manner to be described in greater detail below, to adaptively inform the system as to how a particular subscriber is to be reached, at any point in time, over any one of a number of underlying transport media.

In addition to its hardware components, the communication platform 10 is provided with a text-to-speech engine 24 which functions to translate alpha-numeric coded information, such as an alpha-numeric page or an e-mail, into speech, such that e-mail information or caller-ID information can be presented over an analog POTS device. Similarly, the system includes an interactive voice response (IVR) package by which greetings, invitations and option presentations are made to a caller in conventional fashion.

Characteristically, the communication platform 10 is implemented at the front-end of an entity network, for example, with communication channels established with the TELCO infrastructure and the Internet over T1, T3 or OC-3 connections. Conventional connections are made between the communication platform 10 and a VHF tower farm for wireless communication with PDAs and pagers, for example, and optionally a satellite communication facility 30 which would allow a remote area installation to have access to both a wide area data network and the TELCO infrastructure.

Alternatively, the communication platform 10 is implemented in a location proximate to an LEC central office, such that the subscriber base is not necessarily limited to users of an enterprise-wide network, for example, but rather might include the general public as a whole. In this implementation context, the communication platform combines the functions of a pager service provider, Internet service provider, cellular communication service provider and CLEC.

Accordingly, it will be understood by those having skill in the art that the communication platform of the invention is truly integrated, in that it functions as a front-end switch between subscribers and inbound messages, such that a subscriber is reachable through any currently existent communication medium. In this regard, it should further be noted that the Internet architecture of the system need not be incorporated in every particular one of the platform's implementation methodologies. Indeed, the transaction server 16, Internet information server 18 and SQL server 20 might be combined with a POP3-type mail server and implemented in a centralized location apart from the system's telephony hardware. As will be understood by those having skill in the art, Internet hardware may be located anywhere throughout the Web, and need not have a point of presence proximate to a subscriber. Further, the Internet processing portions of the system's hardware could be implemented in a distributed fashion, with various system implementations hosting particular ones of the system's Internet functionalities.

In operation, the system allows a subscriber to be communicated with using a single-number communication solution. In particular, a subscriber is provided with a single telephone number that allows communicants to speak to the subscriber, leave messages, send faxes, leave pages, schedule appointments and the like. The system communicates with a subscriber using a single, toll-free telephone number (termed herein a Mobile Access Platform number or MAP) through which the system is able to find the subscriber at any one of the set of traditional telephone numbers, based upon user-defined schedules and options. A single-number solution allows call management and delivery to any type of telephone using call forwarding, call waiting, follow-me, meet-me, and one-button callback enhanced telephony services. Further, utilizing the text-to-voice engine (24 of FIG. 1), subscribers are able to interact with textual-based communications. A subscriber has the ability to listen to and even respond to e-mail messages using only the telephone, without recourse to a personal computer or other type of data terminal device.

The single-number solution, coupled with an IVR environment, permits a subscriber to make secure changes to their suite of services and to adjust provisioning settings using only the telephone. For example, a subscriber may turn on a previously-existing flag, in their provisioning area, to thereby cause the system to initiate telephonic communications with the subscriber to read e-mails from a certain selected sender. Additionally, for the follow-me service, the subscriber calls their single-number in order to instruct the system to forward subsequent calls to the phone number making the call.

Subscriber communication with the platform (10 of FIG. 1) is handled through the system's transaction server 16, whether communication is initiated by telephonic means, or over the Internet. Customer record information (provisioning settings, scripts, customer profile data, and the like) is maintained in the system's relational customer database 22, accessible through the SQL server 20. A subscriber wishing to communicate with the system telephonically need only call their unique single-number and enter an identification code on the phone's keypad. The IVR system leads the subscriber through a range of options by means of which the subscriber can access their provisioning area and restructure their provisioning script.

Alternatively, a subscriber communicates with the system over an Internet connection requiring only a browser application to function as a client. Once connected, a subscriber interacts with their personal profile and provisioning information in conventional fashion (through “forms”) and makes such modifications or adjustments as necessary.

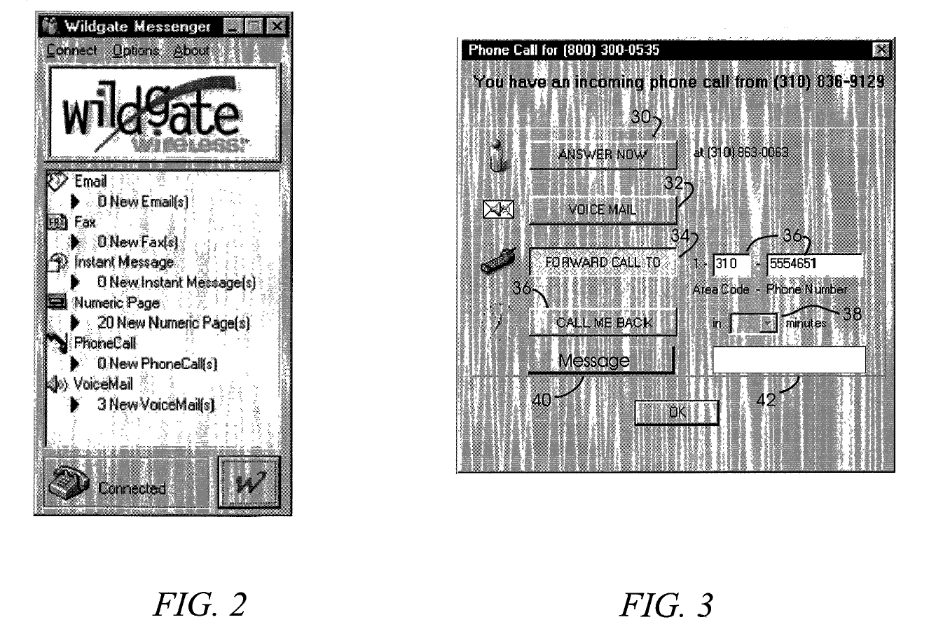

The single-number communication methodology further supports an integrated communication management system, by which the subscriber's single-number functions as a nexus for all communication forms. By logging each communication methodology through a subscriber's number, the system acquires and collates communication attempts made to the subscriber and presents the communication forms to the subscriber in a pop-up window over their Web browser application, as depicted in FIG. 2. Having recourse to the system, a subscriber is able, now, to immediately see how many, and what type, of messages await their attention. For example, in the exemplary embodiment of FIG. 2, a typical subscriber might be notified that they have no new e-mails, no new faxes or instant messages, but have 20 new numeric pages and 3 new voice mails awaiting attention. By selecting any of the options, i.e., e-mail, fax, instant message, numeric page, phone call or voice mail, the content of those options become available to the subscriber and, upon individual selection, are presented to the subscriber over an Internet connection. Voice mails are audited using the subscriber's audio/visual feeds of their personal computer system, in effect turning their computers into a quasi-telephone apparatus.

An additional feature of the Internet messaging capability of the system is its ability to provide what might be termed Web Call Waiting, as depicted in the exemplary embodiment of FIG. 3. For example, a typical Internet user, whether connected through a proprietary network such as AOL, or an Internet service provider such as MSN, has a single telephone line connected to both the computer and a telephone. That single telephone line can be used only for one or the other function at any given time. In the case of a user connected to the Internet using their dial-up line, a contact attempt would result in the caller getting a busy signal. However, and in accordance with the invention, a contact attempt using a subscriber's MAP number would result in the caller hearing a computerized tone similar to the ring of a telephone and see a pop-up window, exemplified in FIG. 3, appear on their browser, alerting them to the fact that someone is calling.

During the progress of any particular telephone call, various forms of in-band information appear on the signal line, including off-hook (busy) signals, ring signals, and the like, as well as Automatic Number Identification (ANI) information and additionally Calling Line Identification (CLID) or Calling Name Identification (CNID) information, if supported.

Briefly, and by way of background, ANI was originally devised as a mechanism by which different telephone companies would be able to determine what account would be charged for a particular call and was also used to let a TELCO operator know who was placing a call. More recently, ANI is used to report to 800 and 900 subscribers, the originator of the calls they have received. ANI has since been enhanced by SS7 (Signaling System 7) and LASS (Local Area Signaling Services) which make CLID and CNID possible. Thus, while ANI is similar to caller-ID services, and may provide the same information, they are actually two different services and ANI information is not necessarily the same as what might appear on a subscriber's caller-ID display.

Specifically, caller-ID is a TELCO offering, developed as a by-product of LASS services, that supports mandated transport of customer-provided number information between interconnecting networks, thereby eliminating the effective inter-LATA-only limitation that heretofore existed. In the case of CLID, only the calling number or an error message and the date/time of the call is returned, while CNID also returns the directory information about the calling number. At a minimum, the name of the calling subscriber is returned.

Using CLID/CNID or ANI information, the system prefixes the call alert with the DID or phone number of the caller, making this information visible at the top of the pop-up messenger window screen. Additionally, the system gives the user various response options, each of which are accessible through “buttons” in well-understood fashion. The subscriber can select “Answer Now” 30 and a designated alternative number, such as a cellular phone on the subscriber's desk, rings. As will be understood by those having skill in the art, the alternative telephone number is designated by the subscriber by interaction with their preferences file, which allows the alternative telephone number to be changed almost at-will by the subscriber.

Alternatively, the user selects “Voice Mail” 32 and the caller is immediately engaged with the system's IVR and receives a voice message that the user has left to greet callers and requests them to leave a message. After the caller leaves a message, the subscriber can immediately listen to the message using the audio/visual capabilities of their computer system. Additionally, a “Forward Call To” button allows a subscriber to forward a call to a telephone number which can be affirmatively inserted into a “Form” field 36. Activating the “Forward Call To” button, causes the intertelephone number to be forwarded to the communication platform (10 of FIG. 1) and the incoming call to be immediately forwarded to that telephone number.

As a further interactivity option, the subscriber might wish to defer the incoming call and select a “Call Me Back” option 36 which initiates a pre-recorded message or a computer-generated voice that informs the caller that the subscriber is on the telephone and to please call back in a specific number of minutes. The time period chosen for responding is settable by the subscriber by entering a numeric value into a time “form” 38 that establishes the number of minutes that the system requests the incoming caller to wait before reestablishing communication. Further, and in accordance with the invention, the text-to-voice engine is invoked by the subscriber's choosing the “Message” option 40 and typing a short text message into a message “form field” 42 for transmission to the system. For example, a subscriber might type “please hold, I'll be right there” into the field 42. In this instance, the caller hears this message, the subscriber disconnects from the Internet, their phone immediately rings and they are connected to the caller.

Thus, and in addition to functioning as a cross-platform communication nexus, the system (10 of FIG. 1) functions much as a TELCO-enhanced services provider and is virtually indistinguishable from an Internet call waiting and answering system.

A particularly advantageous feature of the present invention involves allowing a subscriber to pre-select a particular musical selection, from a database of musical selections, that is played to a calling party while the calling party is “on hold” as a result of any of the previously-mentioned options. Characteristically, a subscriber enters their profile data area (of the system's Web server) and selects one or more musical selections from a menu. As a calling party is placed on hold, the system's IVR offers the calling party a selection of these musical options with the calling party choosing a selection by depressing a numeric indicator on their telephone handset.

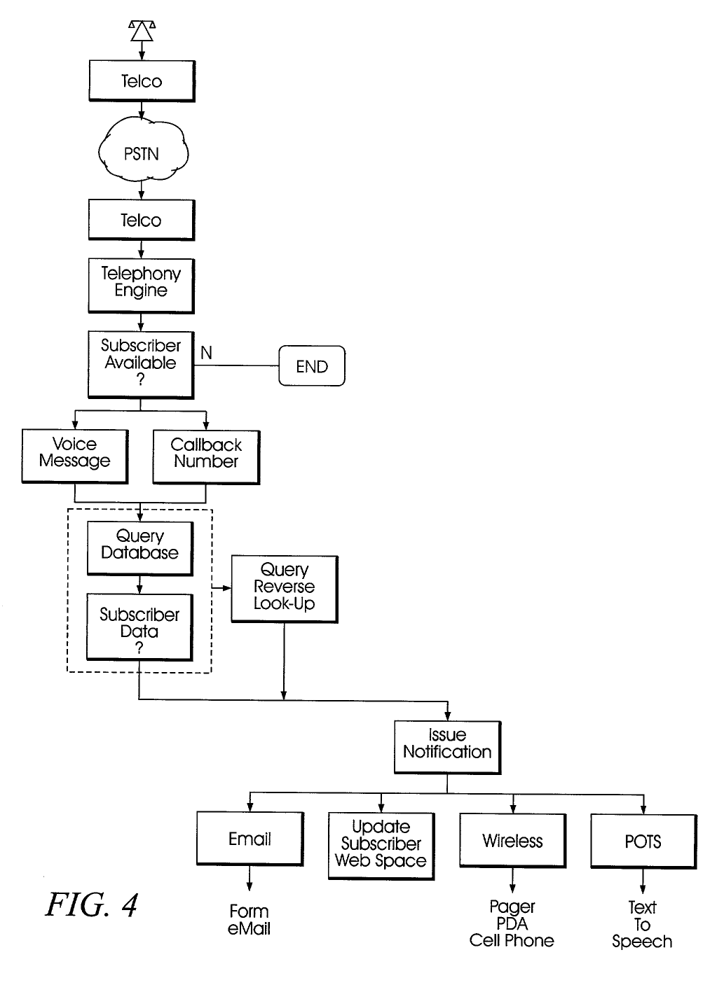

In addition to the above-mentioned features, the system enables an interactive call return methodology, making use of the various portions of cross-platform communication infrastructure. In particular, and with reference to the exemplary flow diagram of FIG. 4, the interactive call methodology initiates when a caller makes a telephone call to a system subscriber, where the subscriber is not available to receive the call. The call is routed through the caller's TELCO and thence through the PSTN to a TELCO infrastructure which is connected to the subscriber through a system implementation. If the subscriber is not available, the system prompts the caller to leave a message along with a call back number at which they are able to be reached. Given the call back number, or any ANI or CLID/CNID information received with respect to the incoming call, the system initiates a search of the database for personal profile data associated with that particular telephone number. If the caller is a subscriber to the system, the system queries the personal information and the address book of the caller and, if found, queues the data for transmission to the called subscriber in the manner to be described in greater detail below.

In the case where the calling party is not a subscriber, the calling party's ANI and/or CLID/CNID information is captured and that information is queued to a subscriber alert process.

In the subscriber alert process, the system generates a form e-mail message which includes all of the calling party's available DID information, along with a time and date stamp. The e-mail is forwarded to the subscriber using the system's mail server. Further, the information contained in the alert e-mail is also published to the subscriber's personalized Web space, by means of a data entry, making that information available to the subscriber whenever they choose to access the system's Web presence.

Additionally, the calling party's DID information is forwarded to any or all of the subscriber's registered wireless devices, such as pagers, cellular telephones or PDAs. In this regard, each subscriber informs the system of how they wish to be notified and the telephone number or access number of the device or devices by which they choose to be notified.

Wireless alerts are transmitted as either an alpha-numeric message, if the receiving device is a pager or PDA, for example, or as an audible alert if the receiving device is a cellular telephone, for example. Audible alerts are generated by processing the calling party's DID information in the text-to-voice engine, by which an audible message is generated for receipt by the subscriber. Similarly, the system initiates telephonic communication by dialing one or more forwarding telephone numbers, designated by the subscriber and, if any one of the numbers is answered, reads the caller DID information to the answering party.

It will be understood by those having skill in the art that the system initiates subscriber alerts in a “broadcast” fashion, with multiple communication options being simultaneously implemented. Multiple telephone numbers are simultaneously dialed while, at the same time, the system attempts to initiate communication with various wireless devices designated by the subscriber. A connection established with any one of the devices indicates a successful communication link and the remaining alert processes (those initiated with respect to telephonic communication) are aborted. E-mail alerts and subscriber website updates are retained.

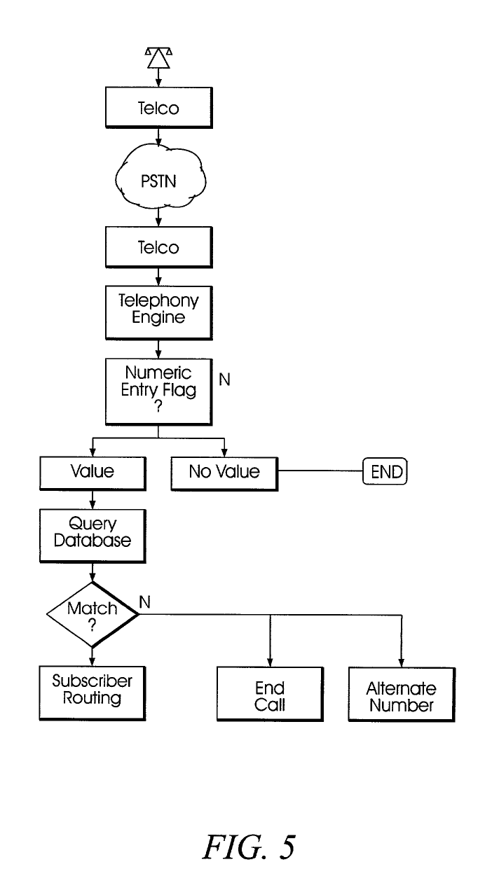

Turning now to the exemplary process flow diagram of FIG. 5, the system is also enabled to provide a call screening with number prompting function in accordance with practice of principles of the invention. To initiate the process, a calling party dials a subscriber's toll-free or local MAP number which, in turn, accesses the subscriber's local platform implementation. The system consults its database to determine whether the subscriber has set a call screening flag. If a call screening flag is enabled, the system (through IVRs) requests the caller to enter a subscriber-defined code sequence, in order to be connected to the receiving party. The code sequence could be implemented as an account number, telephone number, password, or the like, so long as it is an alpha-numeric sequence which can be matched and verified. If the subscriber requires a positive match, the system prompts the caller for an alpha-numeric entry and compares the alpha-numeric entry to the subscriber's code. If no match is found (no value entered), the system defaults to one of three options: end call, divert to voice mail, or route to an alternative number.

In the case of alpha-numeric data entry, the system queries the database table in order to determine if the value input matches the alpha-numeric string defined by the user. If it does not, the system again defaults to the three terminal options: end call, divert to voice mail, or route to alternative number. Where a match is found, the system routes the call to the subscriber.

Although described in terms of a subscriber-defined alpha-numeric code, this call screening with number prompting functionality is particularly suitable for small enterprise systems. For example, a small enterprise need only have a single telephone number, coupled to the communication platform of the invention, with multiple extensions comprising multiple subscriber-defined codes. The caller might be prompted to enter an extension, as opposed to a code, and the system queries the database table in order to determine if the extension number is a valid one. If valid, the system routes the incoming call to that extension in conventional fashion. If the extension is not valid, or if no extension is entered, the system defaults preferably to an alternative number routing, i.e., to an IVRs system or receptionist, with voice mail as a secondary option.

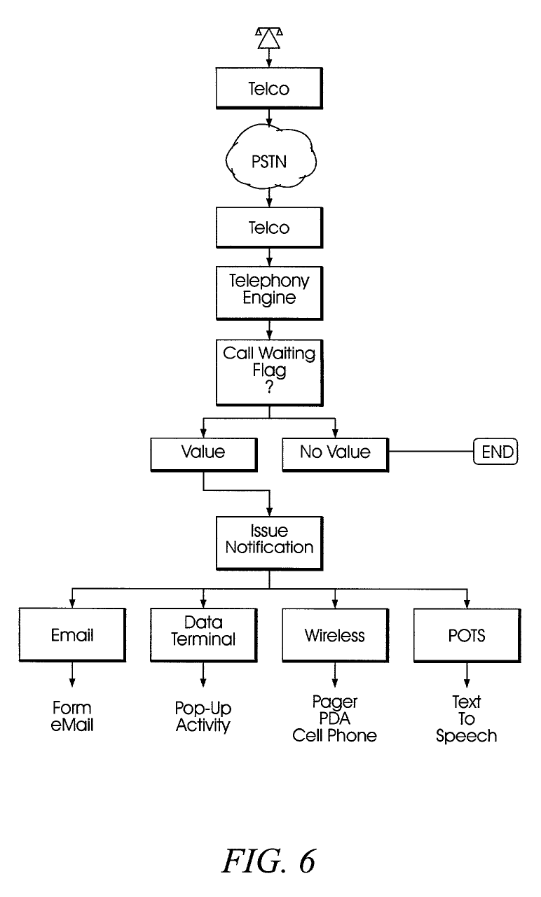

Turning now the exemplary flow diagram of FIG. 6, a simultaneous software call waiting process is substantially similar to the subscriber alert portion of the interactive call return system of FIG. 4, but is predicated upon a subscriber's setting a “call waiting” flag, indicating that they are available through at least one of the various cross-platform communication methodologies that they have designated in their personal profile script. Additionally, the system communicates with a subscriber's desk top computer system in a manner described, above, in connection with the exemplary embodiments of FIGS. 2 and 3. Characteristically, the subscriber has a choice between answering the call at a designated forwarding number, diverting the call to voice mail, forwarding the call to an affirmatively-entered number, requesting the caller to call back within a specified period of time, or to communicate with the caller by entering a text script which is, in turn, translated into an audible message. With the call waiting flag enabled, the system initiates a “time out” process, by which the call waiting time is measured against a subscriber response. Once the time out period is reached, the call is routed to voice mail in conventional fashion.

Additionally, the system enables a particular methodology of call control by way of an e-mail communication protocol. In particular, as a calling party dials a subscriber's MAP number, the system consults the subscriber's profile to determine whether the subscriber has enabled an e-mail processing flag. If the e-mail processing flag is not enabled, the call process proceeds normally. If the e-mail processing flag is enabled, the system composes and sends an e-mail to the subscriber to inquire if the subscriber wishes to take the call. The e-mail acquires the calling party's DID information (whether ANI or CLID/CNID) and identifies the calling party to the subscriber by telephone number and/or name, if available. The call processing options presented to the subscriber include the option to take the call at the subscriber's primary number, send the call to voice mail or to route the call to a telephone number, in a manner similar to the desktop messaging system of FIG. 3. While composing and sending the e-mail notification to the subscriber, the system initiates a waiting period of several seconds, at the end of which the call is processed. In the meantime, the calling party will hear either a prepackaged greeting or a DTMF tone indicating that the telephone is ringing.

The subscriber receives the system's e-mail notification, makes a decision, and replies via e-mail back to the system. The caller is then routed appropriately based upon subscriber input.

It should be noted that the foregoing methodologies are predicated upon a subscriber's preparation of a personalized profile form which contains not only appropriate check boxes to enable the subscriber to indicate which of the various communication flags will be enabled, but also with input “forms” through which the subscriber is able to identify those devices through which they may be reached. Additionally, the subscriber is able to create a personalized address book, via the Internet, within their personalized Web space on the system's Web server. The minimum information the subscriber needs to provide is a name and phone number. When using the system, the subscriber calls their single-number from a touch-tone phone and by invoking the appropriate function by depressing the appropriate key, the subscriber accesses their address book and by spelling the person's name, having the system automatically dial the associated phone number.

Similarly, a subscriber establishes an appointment book in their personalized Web space, with the appointment book being opened to and accessible by designated or authorized persons other than the subscriber. A prospective appointee visits the personalized website of the system's subscriber and requests an appointment by choosing a time and date, in a manner well understood by those having skill in the art. In addition to choosing a time and date, the prospective appointee provides either their e-mail address or a contact telephone number, whether landline, cellular or pager.

The subscriber receives a cross-platform notification from the system with the appointment request. The subscriber either accepts, denies, or reschedules the appointment using the touch-tone keypad of their telephone system or the keyboard or touch pad of their personal data communication device. Following subscriber response, the system returns an appointment status to the prospective appointee by preparing an e-mail response and forwarding the response to the prospective appointee's e-mail address, and/or translating the textual information into voice and initiating a telephone call to the prospective appointee's telephone number.

While the present invention has been described with reference to a number of exemplary embodiments, it will be understood by those having skill in the art that the invention is not limited to the specific structural arrangements and methodological steps exemplified therein. Indeed, the allocation of the various software elements comprising portions of the present invention may be made in substantially different fashion, depending upon the architectural objectives of the system designer. For example, a subscriber may be provided with a client application, whether thick or thin, at the designer's option. A client application would launch at the same time as a subscriber's browser, and would establish communication with the system's Internet presence, in background. Once communication has been established, the client application periodically “pings” the system's Internet presence in order to inform the system that the subscriber is on-line and engaged in a session. Thus, the system would know that the subscriber was available, at least in one particular aspect, and would be able to direct e-mail and other IP-based communications to the subscriber with some degree of surety that the information would be received.

The thickness and/or thinness of the client application would necessarily determine whether the client software participates in development of a subscriber's profile data or if this activity is carried out solely by a centralized network application server, for example. Likewise, rule sets, stored received message lists, message waiting lists, along with the attendant voice mail messages themselves, might be maintained either on the subscriber's data terminal or a centralized database from which it is accessible to a subscriber.

Further, the various communication platforms by which the system is able to communicate with a subscriber, are not intended to be limited solely to those platforms described in connection with the embodiments exemplified herein. Indeed, as other wireless communication methodologies become acceptable for general use, it is certainly within the scope of the invention to incorporate these communication methodologies into the communication platform through the use of an appropriate switch. Accordingly, the present invention is not intended to be limited to the various exemplary embodiments illustrated above, but is rather intended to cover all manner of equivalent structure and operational steps that might be made within the scope and spirit of the present invention as defined by the appended claims.

What is claimed is:

1. In a telecommunication system coupled to communicate between a public switched telephone network (PSTN), a wide area data network, and a wireless communication network, a method for controlling the acceptance or rejection of a telephone call over a wide area data network link, the method comprising:
providing a remote data terminal device coupled to the wide area data network;
providing a communication platform configured as a switch, the platform coupled to communicate over the public switched telephone network (PSTN), the wide area data network, and the wireless communication network;
establishing a communication link between the remote data terminal device and the communication platform using a wide area data network link;
receiving a telephone communication attempt, directed at a subscriber, over the PSTN by the communication platform;
generating an alert notification to the subscriber of the telephone communication attempt; and
forwarding the alert notification to the subscriber over the public switched telephone network (PSTN), the wide area data network, and the wireless communication network simultaneously.

2. The method according to claim 1, further comprising:
offering the subscriber an interactivity option selection list over the wide area data network link;
acquiring ANI/CLID/CNID information from the telephone communication attempt; and
displaying acquired ANI/CLID/CNID information to the subscriber over the wide area data network link.

3. The method according to claim 2, further comprising:
translating said ANI/CLID/CNID information from text to voice; and
generating a voice analog signal, whereby the ANI/CLID/CNID information is read to a subscriber wireless communication device over the wireless communication network.

4. The method according to claim 3, wherein the subscriber wireless communication device is one selected from the group consisting of a pager, a two-way pager, a personal digital assistant, an RF coupled wireless laptop computer, an IR coupled wireless laptop computer, and a cellular telephone.

5. In a telecommunication system coupled to communicate between a public switched telephone network (PSTN), a wide area data network, and a wireless communication network, a method for controlling the acceptance or rejection of a telephone call over a wide area data network link, the method comprising:
providing a remote data terminal device coupled to the wide area data network;
providing a communication platform configured as a switch, the platform coupled to communicate over the public switched telephone network (PSTN), the wide area data network, and the wireless communication network;
establishing a communication link between the remote data terminal device and the communication platform using a wide area data network link;
receiving a telephone communication attempt, directed at a subscriber, over the PSTN by the communication platform;
consulting a subscriber database of feature flags;
determining whether a security flag is enabled;
generating an IVRS request for a calling party to enter a security code;
performing a match between the entered security code and a code sequence associated to the subscriber; and
forwarding the telephone communication attempt to the subscriber if a match is found between the entered security code and the code sequence associated to the subscriber.

6. The method according to claim 5, further comprising:
generating an alert notification to the subscriber of the telephone communication attempt; and
forwarding the alert notification to the subscriber over the public switched telephone network (PSTN), the wide area data network, and the wireless communication network simultaneously.

7. The method according to claim 6, further comprising:
offering the subscriber an interactivity option selection list over the wide area data network link;
acquiring ANI/CLID/CNID information from the telephone communication attempt; and
displaying acquired ANI/CLID/CNID information to the subscriber over the wide area data network link.

8. The method according to claim 7, further comprising:
translating said ANI/CLID/CNID information from text to voice; and
generating a voice analog signal, whereby the ANI/CLID/CNID information is read to a subscriber wireless communication device over the wireless communication network.

9. The method according to claim 8, wherein the subscriber wireless communication device is one selected from the group consisting of a pager, a two-way pager, a personal digital assistant, an RF coupled wireless laptop computer, an IR coupled wireless laptop computer, and a cellular telephone.

10. In a telecommunication system coupled to communicate between a public switched telephone network (PSTN), a wide area data network, and a wireless communication network, a method for controlling the acceptance or rejection of a telephone call over a wide area data network link, the method comprising:
providing a remote data terminal device coupled to the wide area data network;
providing a communication platform configured as a switch, the platform coupled to communicate over the public switched telephone network (PSTN), the wide area data network, and the wireless communication network;
establishing a communication link between the remote data terminal device and the communication platform using a wide area data network link;
providing a database associated to the data network portion of the communication platform;
storing a personalized profile record uniquely associated with each subscriber in the database; and
wherein the personalized profile record comprises a plurality of communication device identification indicia, the communication devices simultaneously accessible through the platform regardless of the underlying network transport medium.

11. The method according to claim 9, further comprising:
receiving a telephone communication attempt, directed at a subscriber, over the PSTN by the communication platform;
consulting the subscriber's personalized profile record;
generating an alert notification to the subscriber; and
forwarding the alert notification to each of the subscriber's plurality of communication devices, the communication devices simultaneously accessible through the platform without regard to the underlaying network transport medium.

12. The method according to claim 11, further comprising:
offering the subscriber an interactivity option selection list over the wide area data network link;
acquiring ANI/CLID/CNID information from the telephone communication attempt; and
displaying acquired ANI/CLID/CNID information to the subscriber over the wide area data network link.
